(19) United States
(12) Patent Application Publication
(10) Pub. No.: US 2015/0001910 A1
(43) Pub. Date: Jan. 1, 2015

(54) Dump Body for a Machine

(71) Applicant: Caterpillar Inc., Peoria, IL (US)

(72) Inventors: Yagneshwar Natarajan, Franklin, WI (US); Theodore A. Moutrey, Taylorville, IL (US); Balachandar Krishnamurthy, Thandalam (IN); Daniel Raymond Hettinger, Monticello, IL (US); Javier Schulze Rojas, Decatur, IL (US); Mohsin Abdul Shaikh, Kodambakkam (IN)

(21) Appl. No.: 14/314,890

(22) Filed: Jun. 25, 2014

(30) Foreign Application Priority Data
Jun. 26, 2013 (IN) 2793/CHE/2013

(51) Int. Cl. B60P 1/28

(52) U.S. Cl. CPC B60P 1/286
USPC 298/1 H

(57) ABSTRACT

The present disclosure provides a dump body for a machine. The dump body comprises a floor, a front wall, a pair of side walls being structured and arranged to form a material collection structure. A contoured surface being formed between at least one combination of the floor, front wall, and the pair of side walls. Further, an exhaust passage having at least a portion of wall being defined by the contoured surface is provided in the dump body, wherein the contoured surface is configured to be in fluid communication with exhaust through the exhaust passage.

### CROSS-REFERENCE TO RELATED APPLICATION

The present application claims the benefit of Indian Patent Application No. 2793/CHE/2013, filed Jun. 26, 2013, which is incorporated herein by reference.

### TECHNICAL FIELD

The present disclosure relates to a dump body for a machine. More particularly, embodiments relate to the dump body of the machine such as vehicle which is configured to prevent material carry back in the dump body.

### BACKGROUND

Dump bodies are manufactured to fit on machines such as trucks. These dump bodies mainly consist of structural components such as a floor, side walls coupled to sides of the floor, and the front wall coupled to a front end of the floor. The dump body can be raised by a hydraulic system so as to eject the material from the floor at an appropriate time. Thereafter, the body can be lowered back to the loading position, so that additional material may be loaded into the body. Certain materials may have a tendency to stick to the dump body. This tendency is more during certain weather conditions. The material in the dump body has a tendency to adhere to the contact surfaces of the dump body (e.g. during cold weather conditions) thereby resisting ejection of the material from the bed of the dump body when the dump body is more vertically oriented or raised to allow the material to evacuate the body. This situation where material remains stuck inside the dump body is referred to as “carry back”.

The material carry back in the dump body is a significant waste in productivity since smaller than expected loads are delivered and after many machine loading cycles the carry back accounts for a significant loss in productivity. Thus, resulting in a higher operating expense. Moreover, besides being extremely inefficient, carry back makes it difficult to manage production, and often coincides with inadvertent abuse of equipment as operators may attempt to eject the carry back by misusing the hydraulic ejection system. Further, as technologically advanced hauling systems are employed accuracy of the Vehicle Information Management System is critical and the weight inaccuracies caused by carry back can cause additional productivity issues, resulting in significant loss of profit to construction and mining companies.

To overcome this problem, it is known to add contoured portions at the junction along the floor and the front wall or panel of the dump body to avoid deep pocketing of the material located at the front of the body that would otherwise collect if this contoured intersection was not employed. Further, it is known to introduce heat from the exhaust of the truck to the main structural rails or tubes within the dump body which eventually results in heating the floor of the dump body.

For example, a dump body is shown in U.S. Pat. No. 6,481,785 (hereinafter referred as '785 patent). The '785 patent has a dump body having a floor, side walls and a head board at the forward end of the dump body, the head board comprising a generally upright panel extending between the floor and side walls and a forward panel extending forwardly from the upper edge of the upright panel. The junction between the floor and the upright panel is of an arcuate configuration. This arcuate configuration serves to facilitate the flow of materials from the body when the body is being tipped rearwardly to deposit its contents and to promote the flow of materials being delivered into the dump body during the loading of the body such that the materials are directed towards the floor of the dump body.

U.S. patent application, U.S. 2012/0169109 (hereinafter referred as '109 patent publication) includes a heated dump body comprising a floor including one or more structural rails or bolsters extending along to support the floor panel and a pair of rails or bolsters to support the side plates of the dump body. The dump body further includes a front plate intersecting the floor and the side plates which includes one or more bolsters spanning and supporting the front plate. The bolsters formed in the floor, the pair of side plates, and the front sheet are each operable to channel exhaust generally to each respective plate in an attempt to heat the body.

The existing solutions to the aforementioned problems may eliminate pocketing however, it may only be effective at the junction between the floor and the front sheet. Unfortunately, the problem of carry back would still exist at other portions of the dump body where there is a tendency for carry back to accumulate. Further, the heated body construct provided by the '109 patent publication may offer an improvement to non-heated bodies however since it does not address certain problem zones of the dump body, which consistently provide areas to accumulate carry back, then carry back continues to accumulate in these zones and hauling productivity is negatively affected. Moreover, introducing exhaust into structural members or bolsters may be slow or not effective enough since the thermal transfer of heat from the exhaust gas within these structural members is distanced from the carry back areas and thus may not adequately heat the surface portions of the body at the sites of the body in contact with the material accumulated in the carry back areas.

In light of the foregoing discussion, it is necessary to develop an improved dump body for the machine such as vehicle with effective heating of material sticking zones to overcome the limitations stated above.

### SUMMARY OF THE DISCLOSURE

The shortcomings of the prior art are overcome and additional advantages are provided through the provision of assembly and a method as claimed in the present disclosure.

Additional features and advantages are realized through the techniques of the present disclosure. Other embodiments and aspects of the disclosure are described in detail herein and are considered a part of the claimed disclosure.

In one non-limiting embodiment of the present disclosure there is provided a dump body for a machine comprising, a floor, a front plate, a pair of side plates, said pair of side plates, front plate and floor being structured and arranged to form a material collection structure. At least one contoured surface being formed between the floor and front sheet and the pair of side plates. Further, an exhaust passage having at least a portion of wall being defined by the contoured surface is provided in the dump body, wherein the contoured surface is configured to be in fluid communication with exhaust through the exhaust passage.

In another aspect, the present disclosure is directed to a method for preventing material carry back in a dump body of a machine. The method comprising acts of: providing at least one contoured surface between a front plate and a floor and a pair of side plates of the dump body; and supplying exhaust gas onto the contoured surfaces through an exhaust passage, wherein at least a portion of wall of the exhaust passage being defined by the contoured surface.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates a dump body disposed on a machine according to one embodiment of the present disclosure.

FIG. 2 illustrates a perspective view of a dump body according to present disclosure.

FIG. 3 illustrates a perspective view of another embodiment of a dump body according to the present disclosure with one of the side plates removed to emphasize the contoured surfaces.

FIG. 4 illustrates a perspective view of the contoured members to be applied to a dump body according to the present disclosure with the body removed to show the arrangement of contoured members.

FIG. 5 illustrates a perspective view of the dump body of FIG. 2 according to the present disclosure with arrangements made in passages of the dump body for directing the exhaust gas to the contoured members.

FIG. 6 illustrates a perspective view of yet another embodiment of the dump body in FIG. 1 without the canopy.

FIG. 7 illustrates a bottom perspective view of the dump body of FIG. 2 having exhaust gas passages in cooperation with the channels and chamber according to the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE DISCLOSURE

The foregoing has broadly outlined the features and technical advantages of the present disclosure in order that the description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

To overcome the problems mentioned above the present disclosure provides an improved dump body for the machines such as vehicles which comprises contoured surfaces at all material sticking zones, along with effective heating of material sticking zones to eliminate carry back in the dump body.

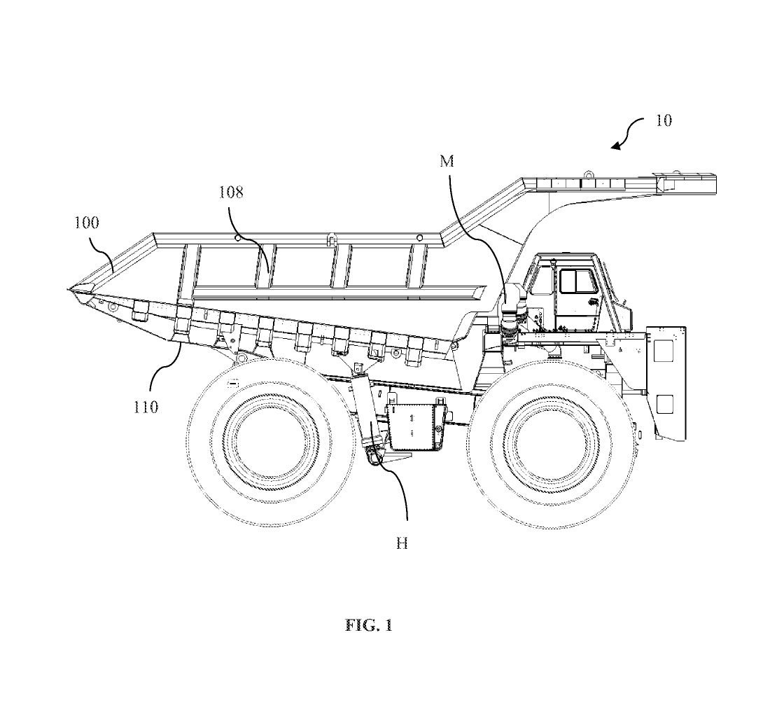

Referring now to FIG. 1 truck 10 includes a dump body 100, a muffler system M, an engine (not shown) and an arrangement 108 for supplying exhaust gas into the dump body 100. The dump body 100 is shown generally in a horizontal or load position and is configured to receive material (e.g. earth, sand, asphalt, miscellaneous debris, etc.) and to carry such material during travel of the truck 10 from one location to another or dump location. At certain times, such as, when arriving at the dump location it is desirable to evacuate or unload the material from the dump body 100. The dump body 100 will be raised at a significant angle which often coincides with a generally obtuse angle position (not shown) as is customary in order to allow evacuation or unloading of the material from the truck. In order to achieve the above, the dump body 100 is raised by a hydraulic system H from the horizontal or lowered position to the raised position. After the material has been ejected from the dump body 100, the dump body 100 is returned to its lowered position. It should be noted that although when the dump body is completely raised it is likely not completely vertical and in fact the dump body 100 may be raised to one of a number of raised positions depending on the desire of the operator and the specific task to be performed in order to eject the material from the bed.

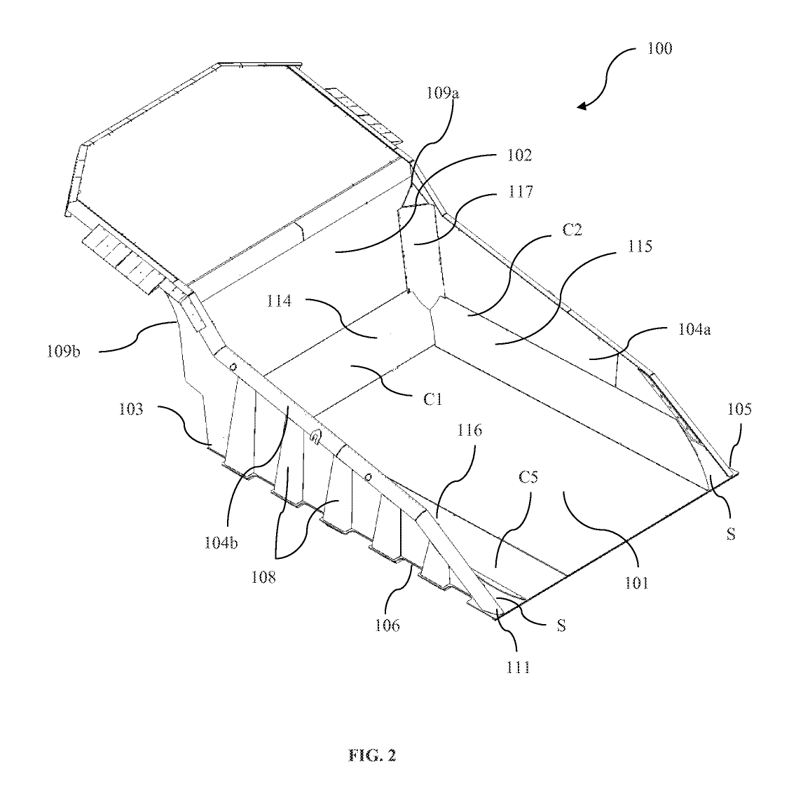

Referring to FIG. 1, the truck 10 can be used at a mine site, for example, to carry material from one location to other location. If the material is wet or has a propensity to stick, the material in the dump body will have a tendency to adhere to edges of the dump body (e.g. wet sand and mud) thereby resisting evacuation of the material from the dump body 100 when the dump body 100 is raised. To reduce this adhering tendency, the dump body 100 is provided with contoured surfaces C1-C6 [FIG. 2,3 and 6] also referred to as Radius Transition Anti Cohesion RTAC surfaces at all the junctions or zones 103, 105, 106, 109a, 109b (where the material tends to stick in the dump body 100). As will be explained in greater detail below the contoured surfaces C1-C6 in the material sticking junctions of the dump body 100 usher evacuation of the material and eliminate pocketing of the material inside the dump body 100.

Referring to FIG. 2, an exemplary embodiment of a dump body 100 according to the present disclosure will be described. Dump body 100 includes floor 101, a pair of side walls 104a and 104b, and front wall 102 which may be fabricated using metal plates and are formed together using fastening and welding techniques as is customary to generally form an enclosed body or bed to hold material and keep lading or cargo inside dump body 100 during transport.

The floor 101 of the dump body 100 is of predetermined shape and is configured to form a base/bed of the dump body 100. The front plate 102 of the dump body 100 is coupled to front side of the floor 101 to form a generally vertical (in the lowered position) first junction 103. The first junction 103 is a connecting junction of floor 101 and front wall 102 of the dump body 100. The pair of side walls 104a, 104b, the front wall 102 and the floor 101 are structured and arranged to form a material collection structure of the dump body 100. In one embodiment of the present disclosure, a generally concave channel member 114 extends along the entire first junction 103 and defines a contoured surface C1 also referred as first Radius Transition Anti Cohesion (RTAC) surface. The channel member 114 which provides contoured surface C1 at the first junction 103 ushers evacuation of the material when the body 100 is in the raised position thereby eliminating the deep pocketing of material at the first junction 103. Further, the dump body 100 comprises a pair of juxtaposed side plates 104a and 104b forming side walls of the dump body 100. The side walls 104a and 104b intersects either sides of the floor 101 forming junctions 105 and 106 respectively. Extending along the entire length of the junction 105 is concave channel member 115 which defines a generally contoured surface C2. Extending along the entire length of the junction 106 is concave channel member 116 which defines a generally contoured surface C5. Each of the channel members 115, 116 include generally contoured surfaces C2 and C5 respectively and are referred to as Radius Transition Anti Cohesion (RTAC) surfaces. The contoured surfaces C2 and C5 running the length of each of channel members 115 and 116 respectively, usher evacuation of material away from the contoured surfaces C2, C5 and thereby deflect the material that may otherwise adhere to the junctions 105, 106.

The front wall 102 intersects the pair of side walls 104a and 104b respectively at junctions 109a and 109b. Junction 109a is a connecting junction of front wall 102 and one side wall 104a of the dump body 100, and junction 109b is a connecting junction of front wall 102 and other side wall 104b of the dump body 100 respectively. Extending along the entire length of the junction 109a is concave channel member 117 which defines a generally contoured surface C3. Similarly, extending along the entire length of the junction 109b is channel member 120 which defines a generally concave surface C4 (neither channel member 120 nor contoured surface C4 are shown, however they are mirror images of channel member 117 and contoured surface C3). Extending along each of the junctions 109a and 109b are channel members 117, 120 (not shown) each of which define contoured surfaces C3 and C4 (not shown) respectively. The contoured surfaces C3 and C4 may be referred to as Radius Transition Anti Cohesion (RTAC) surfaces. The contoured surfaces C3 and C4 of junctions 109a and 109b ushers evacuation of material when the dump body 100 is raised and eliminates material from accumulating in pockets at the junctions 109a and 109b.

Further, when the channel members 114, 115, 116, 117 and 120 are adapted at the junctions 103, 105, 106, 109a and 109b of the dump body 100, passage S will be formed between each of the channel member 114, 115, 116, 117 and 120 and the respective junction 103, 105, 106, 109a and 109b of the dump body 100.

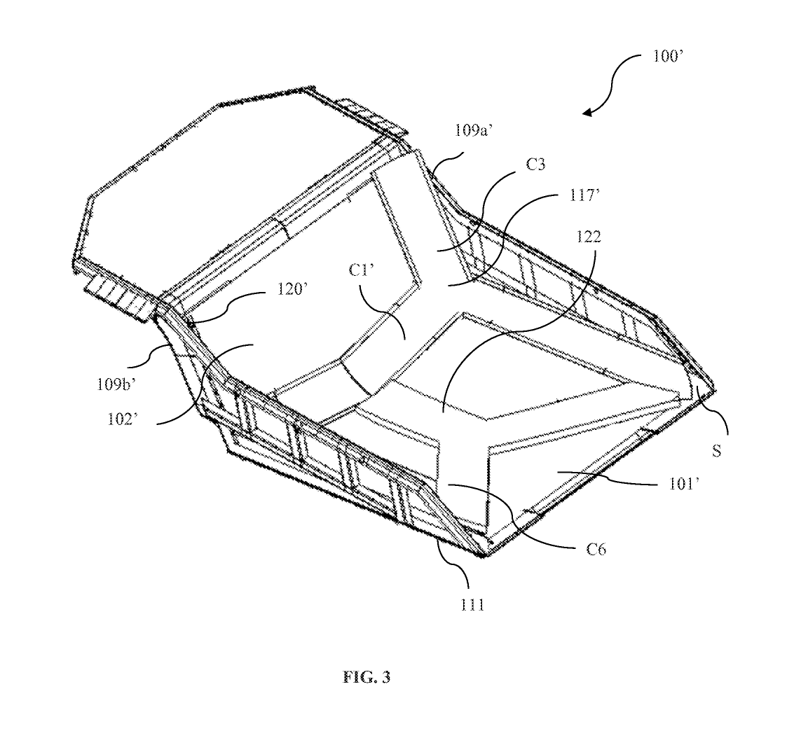

Referring now to FIG. 3, another exemplary embodiment of a dump body 100′ of the present disclosure is shown. The dual slope dump body 100′ includes floor 101′ having a generally “Y-shaped” configuration. Floor 101′ includes Y-shaped channel member 122 extending along the length of Y-shaped floor and defines a contoured surface C6. Further, it may be seen that a continuous space also referred as passage “S” exists between each contoured member and the adjacent body junction in proximity thereto. It may be further understood that this space S forms an exhaust passage along the entirety of the channel members. The contoured surface C6 may also be referred to as a Radius Transition Anti Cohesion (RTAC) surface, and such surface C6 ushers the evacuation of material when the dump body 100″ is raised. Moreover, the intersection of front wall 102′ and floor 101′ establishes and defines V-shaped contoured surface C1′ that ushers evacuation of material as previously explained with other contoured surfaces.

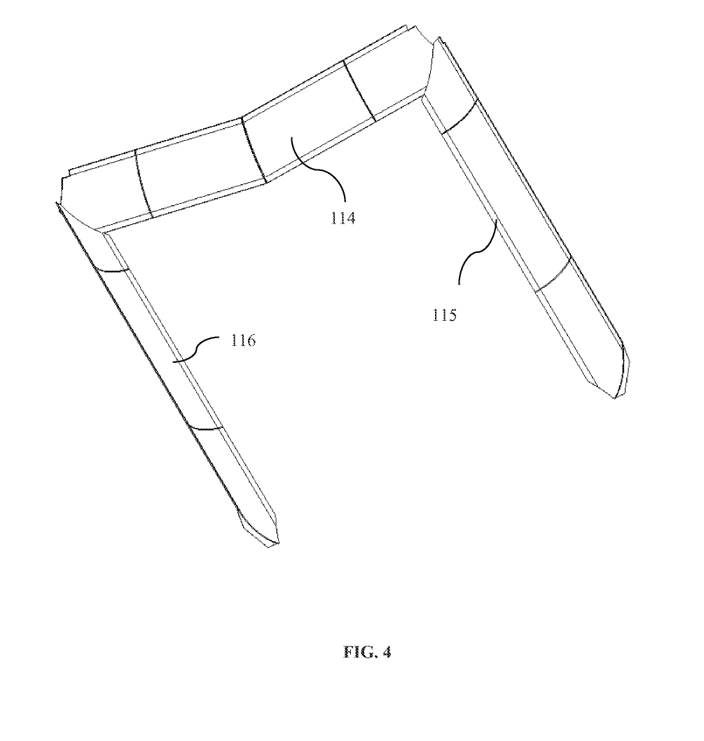

Referring to FIG. 4, shown is a perspective view of contoured channel members 114, 115 and 116 which may be mounted directly to straight transition edges of a common dump body to form the contoured surfaces C1, C2 and C5 similar to those as shown in FIG. 3. Similarly, contoured channel members 117′, 120′ and 122′ (FIG. 3) may be combined with 114, 115 and 116 as a preassembly to be applied to a common dump body to provide a full set of RTAC surfaces at each dump body intersection for pre-existing dump bodies lacking contoured channel members. It will be understood that when the contoured channel members are mounted in an overlaid position relative to the straight transition edges 111 of the dump body 100, a continuous space S is formed between the intersections and the countered channel members. The continuous space or passage S acts as a continuous conduit to transport exhaust gas supplied into S throughout the entire set of contoured channel members.

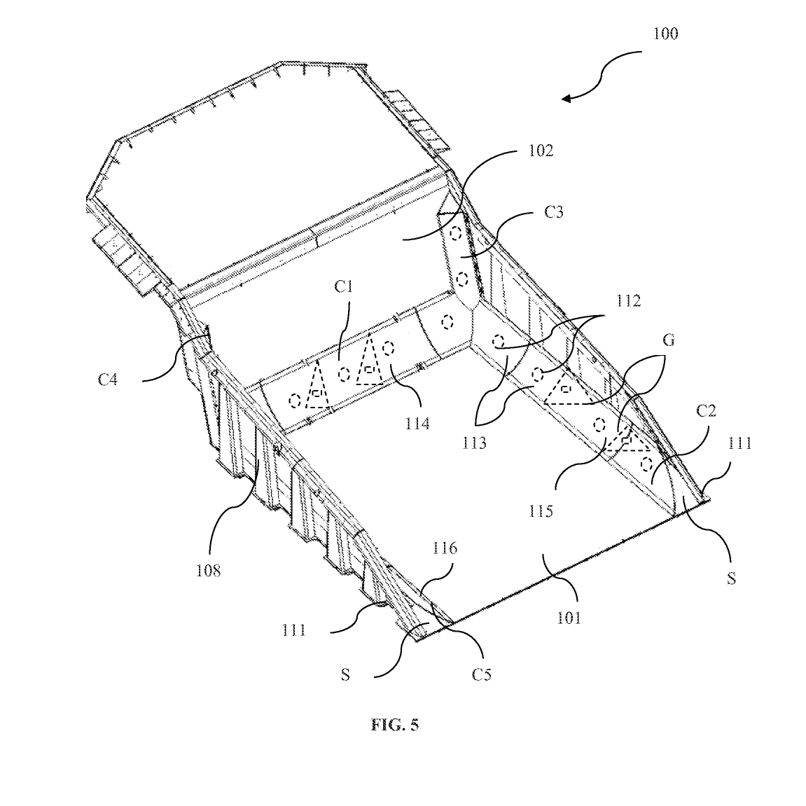

Referring to FIG. 5, shown is a perspective view of a dump body 100 with a fluid communication arrangement disposed in the circuitous opening or continuous passage “S” for receiving exhaust gas and directing the same in contact with the contoured channel members 114, 115, 116, 117 and 120. The passage S is illustrated as a continuous space sandwiched between the various dump body junctions and their associated contoured channel members 114, 115, 116, 117 and 120 which overlay these junctions. In the dump body 100, the passage S is in fluid communication with the exhaust through a plurality of chambers 113. Further, a plurality of provisions 112 are provided on the straight transition edges 111 and on reinforcement channels 108 below the straight transition edges 111 for the exhaust gas into the passage S, and a restrictor including but not limited to a gusset G which may be provided between at least two chambers 113 of the passage S to concentrate the flow of exhaust gas to certain portions of the passage S which are more prone to carryback. For example, the gussets G are provided behind the contoured channel members 114, 115 and 116 positioned adjacent to the exhaust provisions 112. The contoured channel members 114, 115 and 116 can be configured to suit the field installation by a variety of combinations of triangular gussets G and shaping certain gussets G with restrictive holes if some flow is warranted for the particular application. This arrangement of gussets G may be designed to restrict the exhaust gas flow behind certain contoured channel members 114, 115 and 116 (e.g. at regions not as prone to carryback). Therefore, heat through conserved exhaust flow may be better utilized for heating other regions of the contoured channel members more prone to carryback such as in corners and areas subject to deep pocketing. As material is introduced into the dump body, the portion of material that is in direct contact with contoured channel members 114, 115 and 116 will be effectively heated and simultaneously ushered away from the contoured channel members when the dump body 100 is raised thereby providing enhanced anti-cohesion performance of the dump body. Similar configuration of chambers 113 may be formed in the contoured channel members 117, 120 and 122, and the gussets G may be provided behind the channel members 117, 120 and 122 for concentrating the heated exhaust gas.

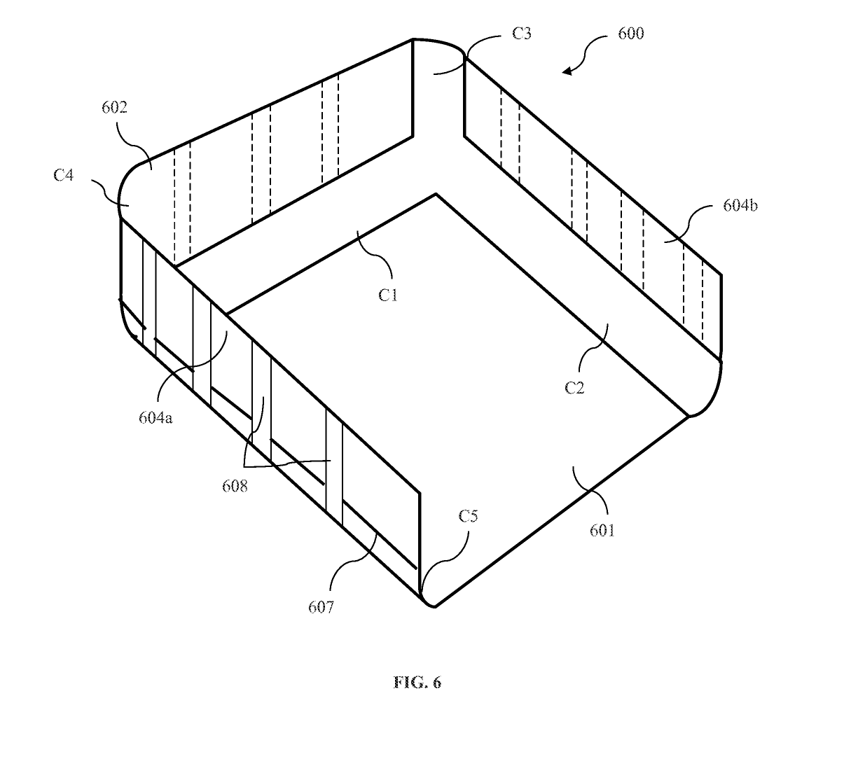

Referring to FIG. 6, shown is yet another exemplary embodiment of a dump body 600. The dump body 600 includes floor 601, a pair of side sheets 604a and 604b, and front sheet 602 which may be together assembled and manufactured from metal plates. Each individual plate may be attached to an adjacent plate through any known method including but not limited to fastening or welding techniques as is customary to generally form an enclosed body or bed to receive and transport material. Alternatively, it is envisioned that the body 600 may be formed out of a single plate and then such plate be properly cut and bent, for example, the side and front panels may be bent into place and welded at appropriate meeting edges to form a unitary body structure. The dump body 600 may include contoured surfaces C1-C5 formed directly into dump body 600 without the need to have separate channel members. Each contoured surface C1-C5 is envisioned to be equivalent to the RTAC surfaces C1-C5 as were described in association with FIG. 2 relative to dump body 100. The contoured surfaces C1-C5 in the dump body 600 usher evacuation of the material when the body 600 is in the raised position thereby eliminating the deep pocketing of material in the dump body 600. In addition, a plurality of exhaust passages 608 are integrally formed within the dump body 600 for directing the exhaust gas to the portions of the body 600 which define the contoured surfaces C1-C5. The exhaust passages 608 may be formed as sealed grooves in each side 604a, 604b and front 602 sheets as well as a passage 607 formed by a continuous sealed groove extending the length of the body 600 along each contoured surface. The passage 607 of the contoured surfaces C1-C5 is configured to be in fluid communication with the passages 608 such that exhaust from the engine will be in fluid communication with the contoured surfaces C1-C5 through passages 607, 608.

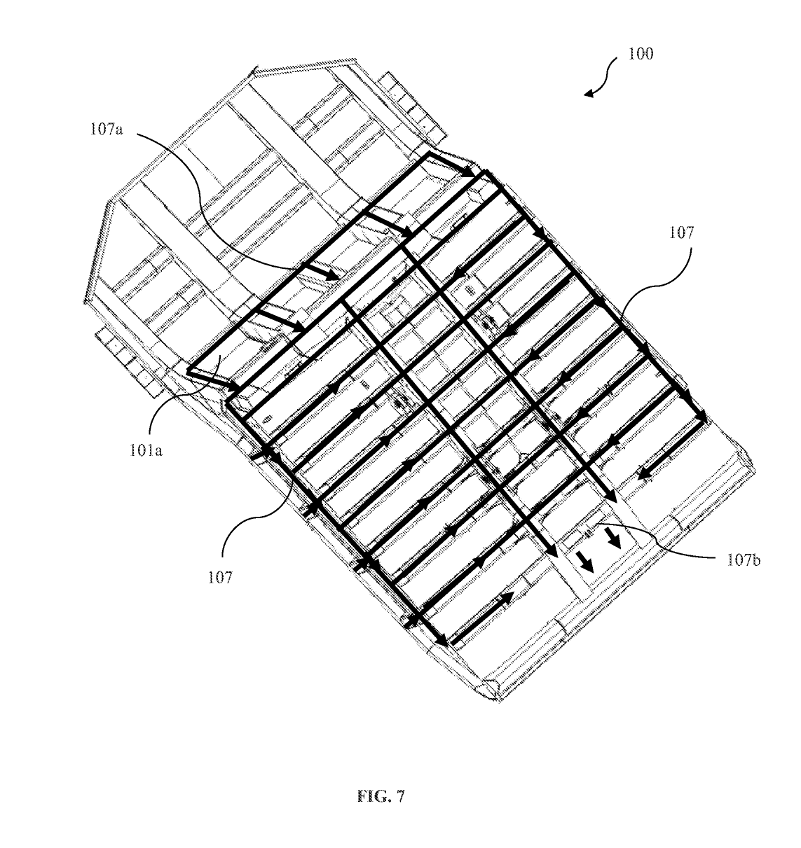

Referring to FIG. 7, shown a bottom perspective view of a dump body 100 in FIGS. 2 and 5 depicting the flow of exhaust gas The dump body 100 includes an exhaust gas routing arrangement to specifically direct exhaust gas directly in contact with the contoured surfaces C1-C6 of the dump body 100. The exhaust gas routing arrangement includes but not limited to a plurality of exhaust passages 107 configured to be connected to an exhaust of the machine. The exhaust gas passages can be configured in a shape including but not limited to circular shape, rectangular shape, square shape, triangular shape, and a portion of the said exhaust passage will be defined by a contoured surfaces C1-C6. The exhaust passages 107 comprises an inlet 107a adapted to be connected to exhaust of the machine through a member including but not limited to a hoses, tubes and pipes for receiving the exhaust gas. The exhaust gas passes inside the exhaust passages also referred as channels 114, 115, 116 and 122, thereby on the contoured surfaces C1-C6. Further, exhaust passages 107 comprises an outlet 107b to send the exhaust gas to atmosphere.

In an embodiment of the present disclosure, the reinforcement channels 108 which are provided around the dump body 100 are configured as exhaust passages 107. The reinforcement channels are configured around the dump body 100 to provide additional strength to the floor 101, side plates 104a and 104b and front plate 102 [shown in FIG. 5] of the dump body and function to absorb impact force imparted to the dump body. The reinforcement channel 108 which is provided in the vicinity of the front sheet 102 of the dump body 100 is configured as an inlet 107a for receiving the exhaust gas from the engine (not shown). The inlet 107a is fluidly connected to a muffler (not shown) in the machine exhaust path for receiving the exhaust gas from the engine. Further, at least one reinforcement channel 108 which is provided at rear end of the dump body 100 is configured as outlet 107b of the arrangement 107 for discharging the exhaust gas. The exhaust gas is received from the inlet 107a is circulated onto the contoured surfaces C1-C6 of the dump body 100 for heating the contoured surfaces C1-C6, and the exhaust gas is ejected out from the outlet 107b at rear of the truck 10.

The reinforcement channels 108 which are provided below contoured surfaces C1, C2 and C5 are configured to receive the exhaust gas from the inlet 107a of the exhaust gas routing arrangement for heating the contoured surfaces C1, C2 and C5. The heating of the contoured surfaces C1, C2 and C5 eliminates the material cohesion and pocketing, and facilitates free flow of material in the dump body 100 when the dump body 100 is raised thereby eliminating the carry back of the material in the dump body 100.

Further, the reinforcement channels 108 which are provided behind the contoured surfaces C3 and C4 of the dump body 100 are configured to receive the exhaust gas from the inlet 107a of the arrangement 107 for heating the contoured surfaces C3 and C4. The heating of the third contoured surfaces C3 and C4 eliminates the material cohesion at the third junction 109a and 109b (shown in FIG. 2) of the dump body 100′″ and facilitates free flow of material in the dump body 100′″ when the dump body 100′ is raised thereby eliminating the carry back of the material.

Further, as shown in FIG. 3 as the dual slope bodies 100′ will have edges in the “Y” intersections 121 (hidden by channel member 122). Therefore, the reinforcement channels 108 which are provided below the “Y” intersections of the floor 101′ are configured as exhaust passages to receive the exhaust gas. The exhaust gas is supplied from the inlet 107a of the exhaust routing arrangement 107 for heating the contoured surfaces C6 formed in the “Y” intersections 121. The heating of the contoured surfaces C6 eliminates the material cohesion at the “Y” shaped intersection and facilitates free flow of material in the dump body 100′ when the dump body 100′″ is raised, thereby eliminating the carry back of the material.

In an exemplary embodiment of the present disclosure, the arrangement 107 for supplying the exhaust gas through plurality of reinforcement channels 108 which are provided below the floor 101 of the dump body 100′up to a predetermined distance from the front sheet 102 for heating the floor 101 of the dump body 100′.

### INDUSTRIAL APPLICABILITY

In one non-limiting embodiment of the present disclosure, the exhaust gas can be supplied onto the contoured surfaces C1-C6 of the dump body 100 through exhaust passages 107. The exhaust muffler M of the truck 10 [FIG. 1] is connected to the exhaust passages 107 and the exhaust gas is supplied through a reinforcement channels 108 of the dump body. The exhaust gas supplied onto the contoured surfaces C1-C6 heats up said contoured surfaces C1-C6 though conduction and convection, thereby heats the material sticking to the countered surfaces C1-C6, which results in slip/fall of the sticky material from the dump body 100. This eliminates the pocketing of material in the dump body 100 which prevents the carry back in the dump body 100.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

We claim:

1. A dump body for a machine comprising:
a floor;
a front plate;
a pair of side wall, said pair of side plates, front plate and floor being structured and arranged to form a material collection structure;
a contoured surface being formed between at least one combination of the floor, front plate, and the pair of side sheets; and
an exhaust passage having at least a portion of wall being defined by the contoured surface, wherein the contoured surface is configured to be in fluid communication with exhaust through the exhaust passage.

2. The dump body as claimed in claim 1, wherein the floor of the dump body is at least one of dual slope floor and flat floor.

3. The dump body as claimed in claim 2, wherein edges in the dual slope floor being configured into a contoured surface.

4. The dump body as claimed in claim 3, wherein the contoured surfaces in the dual slope floor is configured to be in fluid communication with the exhaust through the exhaust passage.

5. The dump body as claimed in claim 1, wherein the contoured surfaces are formed by mounting one or more contoured channel members above straight transition edges of the dump body.

6. The dump body as claimed in claim 5, wherein a passage is formed between the straight transition edges and the countered members is configured into an exhaust gas passage.

7. The dump body as claimed in claim 6, wherein the channels formed between the straight transition edges and the countered members are configured into plurality of chambers.

8. The dump body as claimed in claim 1, wherein reinforcement channels of the dump body are configured as exhaust gas passages.

9. The dump body as claimed in claim 8, wherein at least one reinforcement channel provided in vicinity of the front plate is configured as inlet of the exhaust passage for receiving the exhaust gas from the exhaust.

10. The dump body as claimed in claim 8, wherein at least one reinforcement channel provided at rear end of the dump body is configured as outlet of the exhaust passage for discharging the exhaust gas.

11. The dump body as claimed in claim 8, wherein a plurality of reinforcement channels provided at vicinity of floor of the dump body up to a portion floor from the front sheet are configured as exhaust passages.

12. A method for preventing material carry back in a dump body of a machine, said method comprising acts of:
providing at least one contoured surfaces between a front wall and floor and a pair of side walls of the dump body; and
supplying exhaust gas onto the contoured surfaces through an exhaust passage, wherein at least a portion of wall of the exhaust passage being defined by the contoured surface.

13. The method as claimed in claim 12 comprises act of directing the exhaust gas into a passage formed between a straight transition edges and a countered channel members mounted on the straight transition edges.

14. The method as claimed in claim 12 comprises act of supplying exhaust gas into a reinforcement channels provided in a vicinity of a portion of the floor from the front plate.
